(19) United States
(12) Patent Application Publication
(10) Pub. No.: US 2025/0221395 A1
(43) Pub. Date: Jul. 10, 2025

(54) ELECTRICAL WEED CONTROL SYSTEM AND METHODS OF USE

(71) Applicant: DISCOVERY PURCHASER CORPORATION, Wilmington, DE (US)

(72) Inventor: Sergio Jimenez Tarodo, Düsseldorf (DE)

(21) Appl. No.: 18/408,220

(22) Filed: Jan. 9, 2024

(51) Int. Cl. A01M 21/04

(52) U.S. Cl. CPC A01M 21/046

(57) ABSTRACT

An electric weed control system comprising a frame coupled to array comprising a plurality of flexible electrodes encased in housing.

### BACKGROUND

### Field

The present disclosure relates to systems and methods of use of an electric weed control system.

### Description of Related Art

Conventional weed control systems primarily rely on the use of herbicides. These chemical methods for weed control, although effective, may not be used in areas designated for protection, and can present problems such as contamination of water and nearby land. Additionally, several plant species have become resistant to herbicides commonly used for weed control. Accordingly, there is a need in the art for improved systems and methods for control of weeds and other plants without the use of herbicides.

### SUMMARY

In an embodiment, an electric weed control system can comprise a housing (108) having an opening (109) facing toward the ground (103), an array of flexible electrodes (101) within the housing (108) and which extend toward the opening (109), whereby the flexible electrodes (101) are configured to contact plants extending from the ground (103) and configured to introduce electrical voltage to the plant.

In an embodiment, the housing can extend at least as far as the flexible electrodes whereby ingress by small animals is inhibited and plants permitted (108).

In an embodiment, the array of flexible electrodes (101) are coupled to the housing (108) via an isolator (105).

In an embodiment, the isolator (105) is a block of nonconductive material.

In an embodiment, an upper portion of the plurality of electrodes (602) is of higher stiffness than the lower portion (603).

In an embodiment, the electrodes are coupled to the laterally moveable boom via a removable fastener (601).

In an embodiment, the removable fastener (601) is selected from the group consisting of snap-fit, clamp, bolt, screw, or combinations thereof.

In an embodiment, the array of flexible electrodes (507) comprises between about 2 and 8 rows of flexible electrodes. The array of flexible electrodes can comprise 2, 3, 4, 5, 6, 7, or 8 rows of flexible electrodes (508). The array of flexible electrodes can comprise between about 1 and 8 flexible electrodes per row (508). The array of flexible electrodes can comprise about 1, 2, 3, 4, 5, 6, 7, or 8 flexible electrodes per row (508).

In an embodiment, the array of flexible electrodes can be arranged adjacent to each other (507).

In an embodiment, the array of flexible electrodes are arranged apart (507).

In an embodiment, the flexible electrodes in the same row are spaced about the width of one flexible electrode apart (508).

In an embodiment, the array of flexible electrodes (507) can further comprise a non-conductive backing.

In an embodiment, the flexible electrodes are segmented into strips (603).

In an embodiment, the flexible electrode is segmented into strips (603) between about the lower 25% of the length up to about 75% of the total length. The flexible electrode can be segmented into strips (603) on the lower 25% of the length of the flexible electrode, the lower 50% of the length of the flexible electrode, or the lower 75% of the length of the flexible electrode.

In an embodiment, the segmented strips (603) can move independently.

In an embodiment, the flexible electrode comprises between 2 and 8 strips (603). The flexible electrode can comprise 2, 3, 4, 5, 6, 7, or 8 strips (603).

In an embodiment, the strips on the flexible electrode are adjacent (603).

In an embodiment, there are spaces between strips of the flexible electrode (603).

In an embodiment, the flexible electrodes (507), having a forward and a reverse surface, are paired with an insulator flap configured behind the reverse surface. The insulator flap can be about the same size and shape as the flexible electrode.

In an embodiment, the housing can have an opening (109) toward the ground (103) is segmented, wherein individual segments in the housing, arranged horizontally, move independently.

In an embodiment, the housing can have an opening (109) toward the ground (103) comprises a rigid upper half and a flexible lower half, where the flexible lower half can move in the vertical direction.

In an embodiment, the housing is equally segmented. The housing can be equally segmented into 2 or 4 equal-sized segments.

In an embodiment, the housing has an asymmetric configuration, wherein the segments are not of equal size.

In an embodiment, the housing is segmented into a first one-quarter (25%) segment and second three-quarters (75%) segment.

In an embodiment, the system is coupled to a vehicle in contact with the ground. The vehicle can be a tractor, car, robotic, autonomous, drone, or combination thereof.

In an embodiment, the electric weed control system is coupled to the vehicle by a laterally movable boom extending from the vehicle.

In an embodiment, the vehicle has a front side, a rear side, a first and second side, the first and second sides extending between the front and rear sides, and where laterally moveable boom extends from the front side and is moveable laterally with respect to the main vehicle body in the direction of the first side and in the direction of the second side.

In an embodiment, the laterally moveable boom is moveable such that at least a portion of the housing is extendible past the first side in a first lateral movement, and at least a portion of the housing extendible pas the second side in a second lateral movement.

In an embodiment, the laterally moveable boom moves laterally while maintaining a substantially constant distance from the ground upon which the vehicle moves.

In an embodiment, a method of weed control can comprise contacting a weed with the electric weed control system described herein applying an electrical voltage between electrodes in contact with the plant and electrodes in contact with the ground, an electric current flows from an electrode in contact with a plant through the plant and its roots into the ground and to the electrode in contact with the soil, wherein the weed is contacted for a sufficient period of time to kill the weed.

In an embodiment, the voltage provided through the array is between about 1,000 V and 20,000 V. The voltage provided through the array can be between about 5,000 V and 15,000 V; 10,000 V and 20,000 V; 5,000 V and 12,500 V; or 7,500 V and 17,500 V. The voltage provided through the array can be about 1 kV, 2 kV, 3 kV, 4 kV, 5 kV, 6 kV, 7 kV, 8 kV, 9 kV, 10 kV, 11 kV, 12 kV, 13 kV, 14 kV, 15 kV, 16 kV, 17 kV, 18 kV, 19k V, or 20 kV. The voltage can be about 10,000 V.

In an embodiment, the power provided through the array is between about 1 kW and 20 kW. The power can be between about 1 kW and 5 KW, 5 KW and 10 KW, 2.5 kW and 7.5 kW, 2 kW and 8 kW, 1 kW and 10 kW, 10 KW and 20 KW, 15 kW and 20 kW, or 10 KW and 15 kW. The power can be about 1 kW, 2 KW, 3 KW, 4 KW, 5 KW, 6 KW, 7 kW, 8 kW, 9 kW, 10 kW, 11 kW, 12 kW, 13 kW, 14 kW, 15 KW, 16 kW, 17 kW, 18 kW, 19 kW, or 20 kW.

In an embodiment, the contact time is between about 0.01 seconds and 1 second. The contact time can be between about 0.01 and 0.05 seconds, 0.02 and 0.08 seconds, 0.05 and 1 second, or 0.75 and 1 second. The contact time can be about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, or 1 second.

In an embodiment, the current provided through the array is between 0.01 Amperes (A) and 10 Amperes (A). The current is between about 0.01 A and 1 A, 0.1 A and 10 A, 1 A and 10 A, 5 A and 10 A, 2.5 A and 7.5 A, or 0.05 A and 5 A. The current can be about 0.01 A, 0.02 A, 0.03 A, 0.04 A, 0.05 A, 0.06 A, 0.07 A, 0.08 A, 0.09 A, 0.1 A, 0.2 A, 0.3 A, 0.4 A, 0.5 A, 0.6 A, 0.7 A, 0.8 A, 0.9 A, 1 A, 2 A, 3 A, 4 A, 5 A, 6, A, 7 A, 8 A, 9 A, or 10 A.

### BRIEF DESCRIPTION OF THE DRAWINGS

FIG. 1A-B depicts the electric weed control system described herein coupled to a vehicle, the vehicle can have a standard combustion engine, hybrid, or electric motor. Side view (1A) and top view (1B).

FIG. 1C depicts the electric weed control system described herein (top view). The outer shell is depicted, the outer shell is constructed of non-conductive material. The electric weed control system comprises a single point of attachment to a boom that can be coupled to a vehicle to provide locomotion and power. Also shown are flags that can be affixed to the front of the electric weed control system.

FIG. 1D depicts the electric weed control system coupled to a vehicle.

FIG. 2 depicts the electric weed control system described herein (top view) coupled to a vehicle to provide power and locomotion. The electric weed control system is coupled to the vehicle by means comprising a single boom, coupled to a joint that allows for side-to-side movement of the electric weed control system, e.g., up to 45° to each side.

FIG. 3 depicts the electric weed control system described herein (top view) with outline of the protective shell. The boom is connected to the electric weed control system by a single point. The single point of coupling is isolated, and fully insulated from the vehicle, for example, providing locomotion and power to the electric weed control system.

FIG. 4 depicts the electric weed control system described herein (top view). The electric weed control system can comprise an array of flexible electrodes. The array can comprise three rows, the first two rows can comprise staggered sets of flexible electrodes with the last row comprising a full row of flexible electrodes. The first two sets of flexible electrodes can act as contact electrodes and the rear set of flexible electrodes can act as ground electrodes. The array is segmented allowing it to adapt to landscape with different elevations and obstacles. The electric weed control system has a single connection point to the electrodes (the frame is not electrified).

FIG. 5 depicts the electric weed control system described herein (bottom view). The electric weed control system can comprise an array of flexible electrodes. The array can comprise three rows, the first two rows can comprise staggered sets of flexible electrodes with the last row comprising a full row of flexible electrodes. The first two sets of flexible electrodes can act as contact electrodes and the rear set of flexible electrodes can act as ground electrodes.

FIG. 6 depicts flexible electrodes, as coupled to the electric weed control system (A), alone (B), or flexed (C). The flexible electrodes are conductive reinforced polymer electrode, optionally a silicone backed spring steel. The flexible electrodes can be replaced individually as modular units with coupling means. The flexible electrode comprises a head with an extension, the extension is continuous upper half and discrete individual flaps in the lower half.

FIG. 7 depicts the electric weed control system comprising a segmented housing comprising an upper and lower sections. (A) front view of an array of flexible arrays on a flat (uniform) surface; (B) front view of the array configuration on a curb showing the upper rigid housing and the lower, flexible housing, that is configured to move in the vertical direction; (C) front view of array going over a curb (e.g., non-uniform surface), where the rigid upper housing is static and the lower flexible housing is configured to move in the vertical direction, allowing for constant contact between the flexible electrodes and the ground.

### DETAILED DESCRIPTION OF THE EMBODIMENTS

In order that the invention herein described can be fully understood, the following detailed description is set forth. Various embodiments of the invention are described in detail and can be further illustrated by the provided examples. Additional viable variations of the embodiments can easily be envisioned.

### Definitions

Unless defined otherwise, all technical and scientific terms used herein have the same meaning as those commonly understood by one of ordinary skill in the art to which this invention belongs.

As used in the description herein and throughout the claims that follow, the meaning of “a,” “an,” and “the” includes plural reference unless the context clearly dictates otherwise.

### Electric Weed Control System

Weeds are a common problem in non-cultivated areas as they damage infrastructure, increase risks (e.g., of fire) and may affect negatively to the environment as well human health. Use of electricity could be one method for the control of weeds on an efficient and environmental friendly way. Two electrodes are required, as electricity has to be pushed into the weeds, it flows into the roots and has to come back to the source of energy. In the non-crop environment (e.g., municipalities, industrial areas, railway), we can find many ground situations and the application can be done close to obstacles, people, and animals. The challenge is to ensure electricity is transferred to the target weeds in an efficient a safe way.

The electric weed control system described herein can be used in areas that restrict the use of herbicides. Further, the electric weed control system described herein is effective against herbicide resistant plants. Without wishing to be bound to a particular theory, the inventors found that the electric weed control system described herein kills plants, e.g., weeds or other targeted vegetation by conducting electricity through the plant, through the roots, into the ground. This is an effective, non-chemical, approach to weed control that is not restricted by the plant type.

The electric weed control system described herein can be used in agricultural applications where the ground is uneven, contains obstacles, or is otherwise non uniform. The electric weed control system described herein can also be used in urban and suburban settings for weed control on roads, parks, stairs, and other infrastructure where the terrain is uneven, and the use of herbicides is not allowed. The electric weed control system described herein can be used for weed control in circumstances where the weeds are interspersed in structures, e.g., roads, curbs, sidewalks, buildings, such that the terrain is broken and uneven.

The electric weed control system described herein comprises an array comprising a plurality of flexible electrodes, an outer shell encasing the array, and a single point of connection to a power source. The flexible electrodes can be electrically coupled to the single point of connection to the power source and the outer shell is made of non-conducting material to provide shielding from the voltage. The array can be configured to be attached to a propulsion system (e.g., vehicle, carrier) via a movable boom.

The array is arranged on a frame that can be segmented, allowing for movement in the vertical direction relative to other elements of the frame. In addition, the individual electrode units are flexible, allowing them to brush over a surface. Also, the individual electrode units can be segmented allowing for independent movement of adjacent electrode units. This allows the frame to move over objects, obstacles, and broken terrain, e.g., curbs, sidewalks, rough ground, while having the flexible electrodes maintain contact with the ground.

The electric weed control system described herein can be mounted on a vehicle able to maneuver in the target areas. It can comprise different subsystems to ensure a safe and efficient control of weeds using electricity.

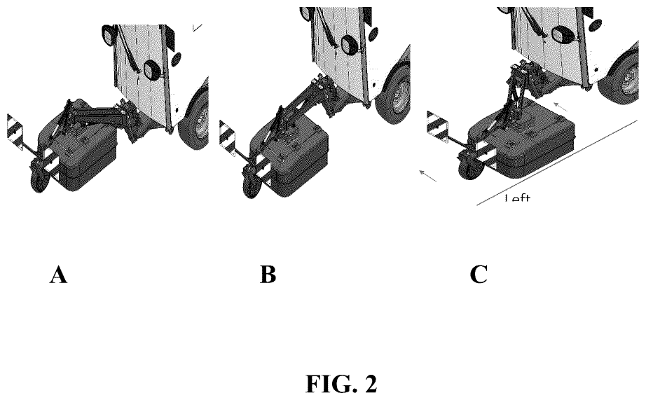

Laterally movable applicator boom comprising electrodes. 102 Areas of weed control may be not directly accessible under the vehicle profile, therefore an applicator boom able to move sideways and also beyond the vehicle width profile is advantageous. FIG. 2A-B The boom comprises an articulated joint coupled to the vehicle with an arm. 202 This arm is also held by a front jockey wheel to ensure adequate height to weeds, even under rough surfaces. The arm allows movement in all directions.

Isolator between boom and vehicle frame. 305 Physical point of contact between boom and vehicle frame relies on an isolator block able to withstand the forces produced between the two parts and to act as an electrical isolator for high voltage. The isolator block is robust enough to avoid energizing the vehicle in case of a failure (e.g., leakage) in the electrode array module.

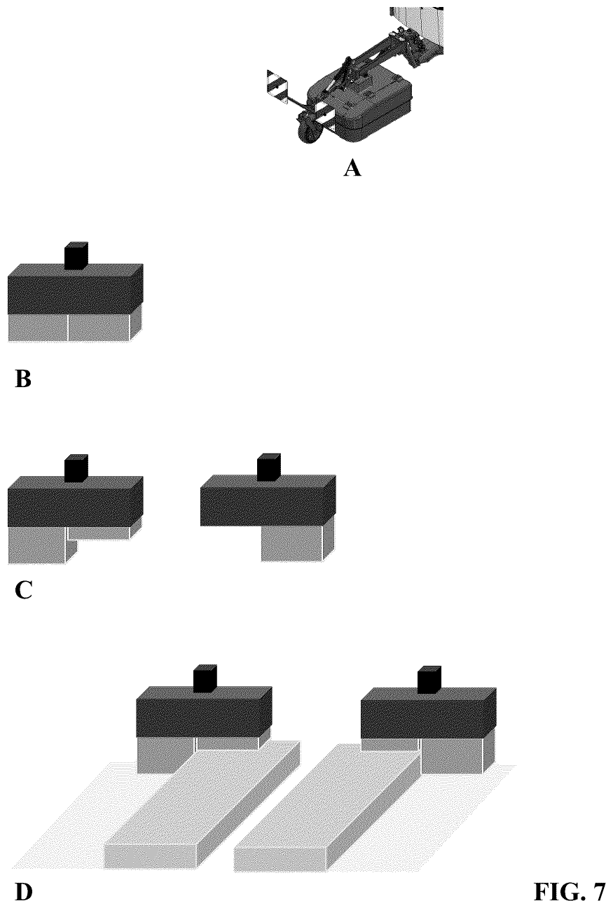

Height adjustable shielding. The housing extends at least as far as the flexible electrodes whereby ingress by small animals is inhibited and plants permitted (108). Weed control of weeds in certain areas like curbsides require the treatment of weeds at two heights (e.g., one step) at once for maximum efficiency. FIG. 7A-C That could be done directly by placing electrodes, half of them (on the longitudinal direction) hanging on more than the others. This causes electrodes may be exposed to the exterior when normal shielding is used. Height adjustable shielding, having two different zones (left and right) can be adjusted separately, and ensures the shielding covering the boom electrodes up to the ground. A lateral wheel (while the arm pushing to the side) keeps the boom on the same position.

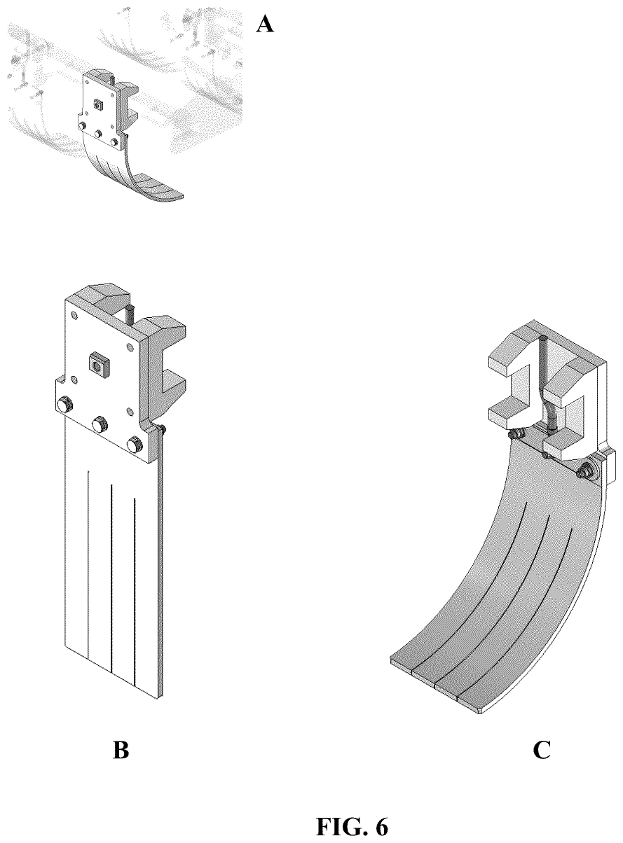

Electrodes with independent sections on the edge that make a first contact with the ground and weeds. FIG. 6 In non-crop situations, typically neither ground surface is even nor can be compacted/flattened by the pressure of an electrode. Small weeds may not be accessible to the electrodes as they are hidden in gaps or by nearby elevated particles like stones. The flexible electrodes have a balance between stiffness provided by the unity of the electrode on the upper part to avoid big weeds create a curtain effect and contact with nearby smaller weeds is not achieved; and flexibility in the lower part of the electrode by having small independent sub-electrodes than can better manage irregularity of the ground including cracks, small holes and ballast. More flexibility is obtained from a relative independent movement in the lower part from the sub-electrodes. Rigidity can be measured in terms of gigapascals (GPA). The maximum stiffness can be about 100 GPA.

Easily-fit connection between electrodes and application boom frame. The electrodes in the system that will wear out with time as there is a constant physical contact with the ground. It is expected that the electrodes will be replaced regularly. Replaceable electrodes are configured to be attached and detached from the frame. This system saves time and minimize set-up failures. FIG. 6A

### Methods of Controlling Weeds

The electric weed control system can be coupled to a vehicle to supply power and locomotion. The electric weed control system, for example, coupled to a vehicle can be used to control weeds, e.g., kill weeds, in an area where herbicide application is restricted (or not allowed at all).

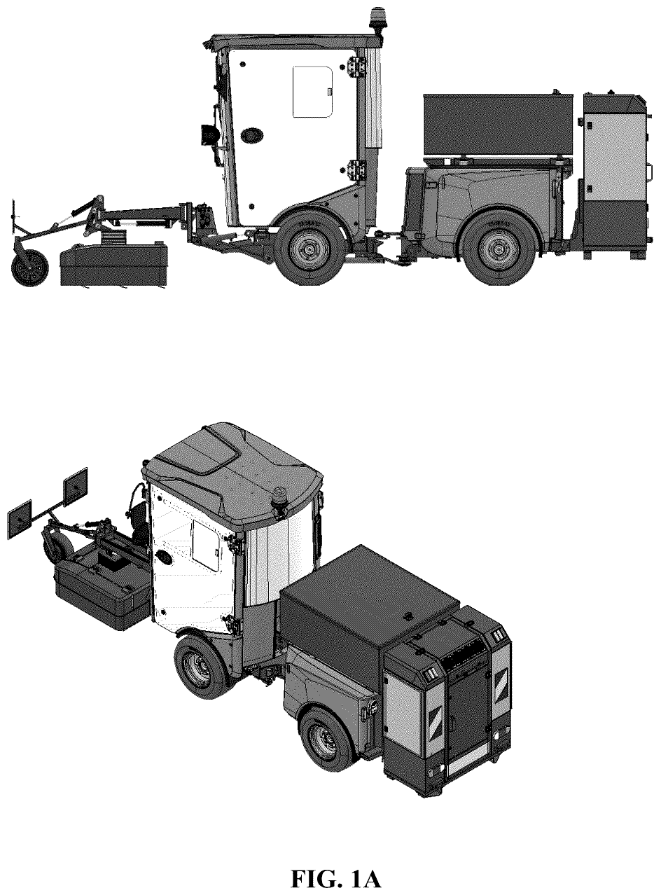

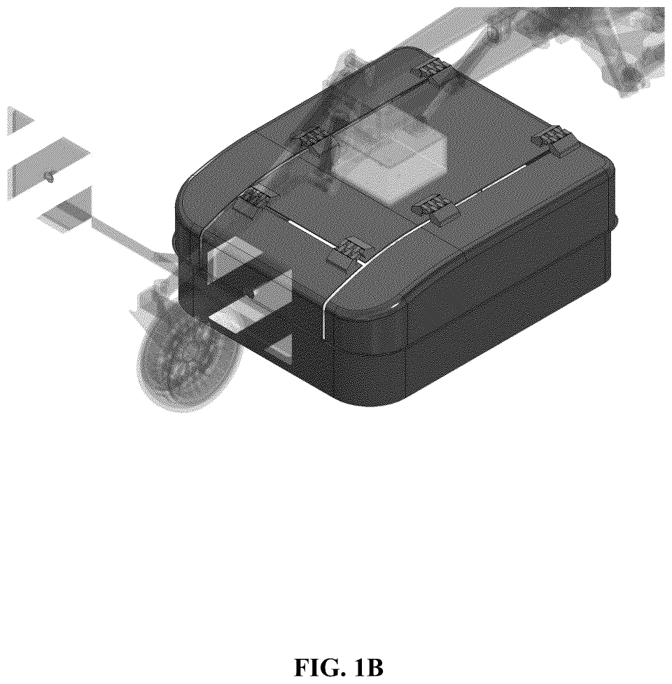

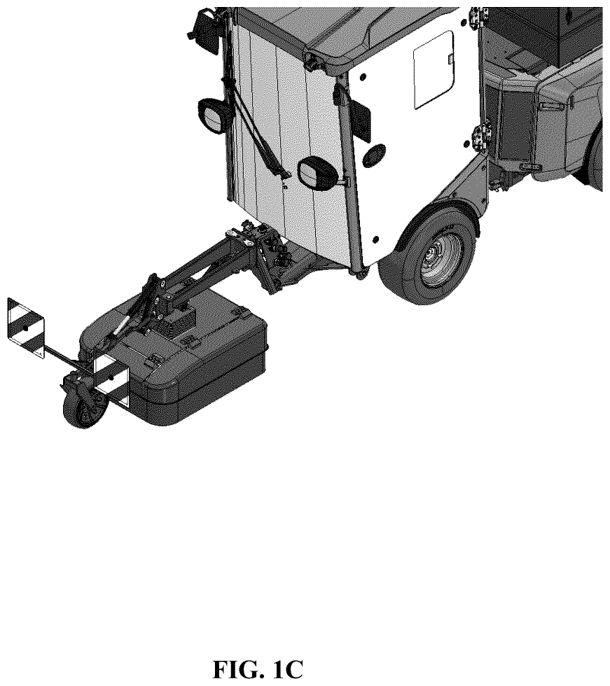

In reference to the figures, FIG. 1A depicts an electric weed control vehicle 100 comprising: a main vehicle body in contact with a ground 103; a laterally movable boom 102 extending from the main body, the laterally movable boom comprising a housing having an opening (109) toward the ground 103, and an array of flexible electrodes 101. The laterally movable boom is configured to allow movement side-to-side, e.g., 180° total. The laterally movable boom is affixed to the front of the vehicle and the electric weed control system. The ground 103 may include the earth or portions thereof, such as a road, brick, or sidewalk, or portions that include soil, sand and the like. The vehicle can have a front side, a rear side, a first and second side, the first and second sides extending between the front and rear sides, and where laterally moveable boom extends from the front side and is moveable laterally with respect to the main vehicle body in the direction of the first side and in the direction of the second side. The vehicle comprises a chassis, an enclosure for an operator, and an engine, which can be electrical.

The vehicle may be of any configuration that allows for coupling to the electric weed control system and can be operated by an operator and/or remotely. The electric weed control system described herein does not need to be coupled to a vehicle, including operator-controlled vehicle. The electric weed control system can be autonomous, e.g., self-driving. The electric weed control system can also be piloted by a computer, e.g., drone or remotely controlled. The electric weed control system need only be coupled to a propulsion system, whether an operator controlled vehicle, a drone, or self-driving vehicle.

The vehicle can further comprise an electrical power supply 107. The electric weed control system described herein can be coupled to a power source to provide electricity. 107 The electric weed control system described herein kills plants and plant parts using an electrical current applied directly to the plant. The electrical current may be Direct Current (DC) or Alternating Current (AC) up to 20000 V voltage.

The electric weed control system described herein maximizes the contact area between the target plants and the electrode allowing for a maximum amount of current to flow through the plant into the ground, killing the plant. The different target plants have different resistances, locally and temporally for a variety of reasons. The inventors discovered that, despite the variability in resistance from the plants, the electric weed control system described herein showed unexpected efficiency in killing plants.

The ranges in which the electric weed control system operates generally depends on the soil resistance. For example, in some instances, low energy is required to force electricity through the plant and soil, in others higher amount of energy is required.

The voltage can be between about 1,000 V and 20,000 V. The voltage can be about 10,000 V. The voltage can be between about 5,000 V and 15,000 V; 10,000 V and 20,000 V; 5,000 V and 12,500 V; or 7,500 V and 17,500 V. The voltage can be about 1 kV, 2 kV, 3 kV, 4 kV, 5 kV, 6 kV, 7 kV, 8 kV, 9 kV, 10 kV, 11 kV, 12 kV, 13 kV, 14 kV, 15 kV, 16 kV, 17 kV, 18 kV, 19 k V, or 20 kV.

The power can be between about 1 kW and 20 kW. For example, the power can be between about 1 kW and 5 kW, 5 KW and 10 KW, 2.5 kW and 7.5 kW, 2 KW and 8 kW, 1 kW and 10 KW, 10 KW and 20 kW, 15 kW and 20 kW, or 10 KW and 15 kW. The power can be about 1 kW, 2 KW, 3 KW, 4 KW, 5 KW, 6 kW, 7 kW, 8 kW, 9 KW, 10 KW, 11 kW, 12 kW, 13 kW, 14 kW, 15 kW, 16 kW, 17 kW, 18 kW, 19 kW, or 20 kW.

The contact time can be between about 0.01 seconds and 1 second. For example, the contact time can be between about 0.01 and 0.05 seconds, 0.02 and 0.08 seconds, 0.05 and 1 second, or 0.75 and 1 second. The contact time can be about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, or 1 second.

The current can be between 0.01 Amperes (A) and 10 Amperes (A). The current can be between about 0.01 A and 1 A, 0.1 A and 10 A, 1 A and 10 A, 5 A and 10 A, 2.5 A and 7.5 A, or 0.05 A and 5 A. The current can be about 0.01 A, 0.02 A, 0.03 A, 0.04 A, 0.05 A, 0.06 A, 0.07 A, 0.08 A, 0.09 A, 0.1 A, 0.2 A, 0.3 A, 0.4 A, 0.5 A, 0.6 A, 0.7 A, 0.8 A, 0.9 A, 1 A, 2 A, 3 A, 4 A, 5 A, 6, A, 7 A, 8 A, 9 A, or 10 A.

FIG. 1C depicts an electric weed control system 110 comprising: a housing 108 with an upper portion 104 and a lower portion 106, the housing having an opening 109 toward the ground 103, and an array of flexible electrodes coupled to an insulator adaptor 105. The insulator adaptor can be comprised of non-conductive material. The housing encloses the frame upon which the array comprising a plurality of flexible electrodes are mounted. The housing can be constructed of non-conductive material. The upper portion 104 is rigid, and the lower portion 106 is flexible. The upper portion can be a hard plastic, composite, fiber glass or metal covered with an isolator material, and the lower portion may be elastomeric polymer or rubber. For example, the lower portion can comprise ethylene propylene diene monomer, also with good electrical isolation, mechanical abrasion and biodegradability properties; natural rubber or butyl rubber. FIG. 1D depicts an electric weed control system coupled to an electric weed control vehicle via a laterally movable boom 102 extending from the main body, the laterally movable boom comprising a housing having an opening 109 toward the ground 103, and an array of flexible electrodes 101.

In reference to the figures, FIG. 2A-C depicts the movement possible with the laterally movable boom 202 coupled to the array of flexible electrodes 101. FIG. 2B depicts the electric weed control system aligned with the laterally movable boom. FIG. 2A depicts the electric weed control system moved to the right of the laterally movable boom. FIG. 2C depicts the electric weed control system moved to the left of the laterally movable boom.

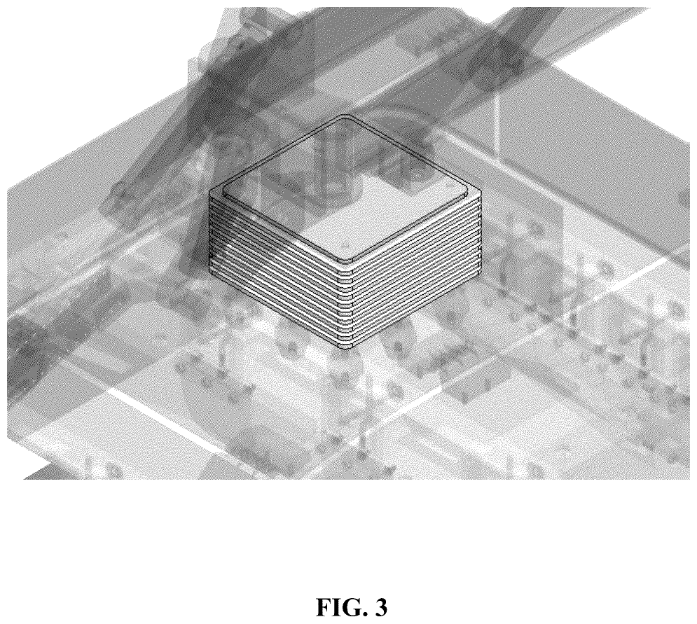

In reference to the figures, FIG. 3 depicts a close up of the array of flexible electrodes with the laterally movable boom 302 coupled to an insulator adaptor 305 that is coupled to a frame 306 comprising a plurality of flexible electrodes. The housing having an opening toward the ground is shown as partially transparent to show insulator adaptor 305 and the frame 306. The insulator may be a block of non-conductive material.

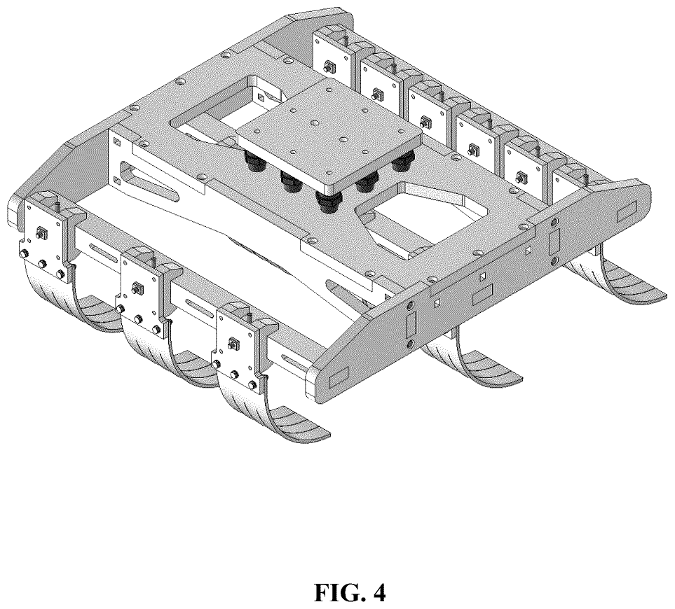

In reference to the figures, FIG. 4 depicts the electric weed control system 400 comprising a frame 406 contained inside housing having an opening towards the ground where the insulator adaptor 408 is coupled to a frame 406 supporting a plurality of flexible electrodes 407. The frame may comprise at least about three rows of flexible electrodes. For example, the frame may comprise between about 2 and 6 rows of flexible extrudes. The frame may comprise 3 rows of electrodes. The flexible electrodes may be staggered (first frow) or a full row where the flexible electrodes are aligned side-by-side. The flexible electrodes can be between about 75 and 225 mm wide. For example, the flexible electrodes can be between about 100 and 200 mm wide. The electrodes can be 100, 110, 120, 130, 140, 150, 160, 170, 180, 190, or 200 mm wide.

The configuration of the boom can be between about 600 and 1200 mm wide. For example, the boom can be 600, 700, 800, 900, 1,000, 1,1,00, 1,200 mm wide. The boom can be about 600 mm or 1,200 mm wide.

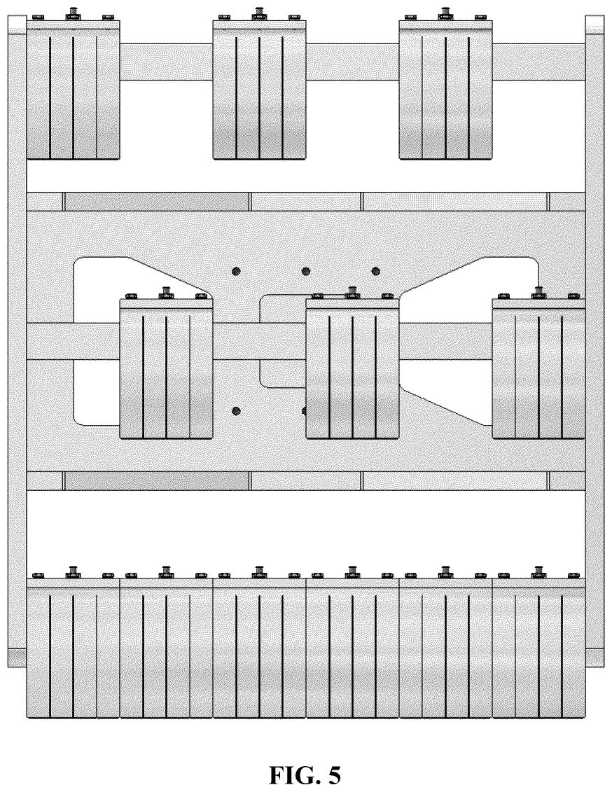

In reference to the figures, FIG. 5 depicts the electric weed control system comprising a frame 506 contained inside housing having an opening towards the ground supporting a plurality of flexible electrodes 507 (an array of flexible electrodes). The frame may comprise at least about three rows of flexible electrodes (508). For example, the frame may comprise between about 2 and 6 rows of flexible extrudes. The frame may comprise 3 rows of electrodes. The flexible electrodes may be staggered (first frow) or a full row where the flexible electrodes are aligned side-by-side. The frame may comprise 3 rows, the first row (front row) can comprise 3 flexible electrodes staggered apart, e.g., each spaced one flexible electrode width apart. The second row (middle row) can comprise 3 flexible electrodes staggered apart, e.g., each spaced one flexible electrode width apart. The second row flexible electrodes may be arranged opposite the first row, e.g., the electrodes are placed in an open space and not directly behind a flexible electrode in the first row. The third row (back) can comprise 6 flexible electrodes, arranged adjacent to one another.

The rows of flexible electrodes can be spaced at about 600 mm. The rows of flexible electrodes can be spaced at between about 500 and 700 mm. For example, the rows of flexible electrodes can be spaced at about 500, 550, 600, 625, 650, 675, or 700 mm.

Without wishing to be bound to a specific theory, the flexible electrodes receive power via the single power coupling in the array. The flexible electrodes make contact with the plant, which completes a “circuit,” causing electricity to flow from the flexible electrode through the plant, through its roots, and into the ground. The passage of electricity throughout the plant, including the root structure, allows for efficient killing of the plant. For example, some electrodes can make contact with the plant, other electrodes make contact with the ground. An electrical voltage is applied between the electrodes in contact with the plant and the electrodes in contact with the ground. As a result, electric current flows from an electrode in contact with a plant through the plant and its roots into the ground and to the electrode in contact with the soil.

The flexible electrodes may be of uniform length. The flexible electrodes can be about 300 mm in length. For example, the flexible electrodes can be between about 200 mm and 400 mm in length. The flexible electrodes can be between about 250 mm and 350 mm, 275 mm and 325 mm, or 290 mm and 310 mm in length. The flexible electrodes can be 200, 225, 250, 275, 300, 325, 350, 375, or 400 mm in length.

Each flexible electrode can comprise between 2 and 8 strips. For example, the flexible electrode can comprise 4 strips. The strips can move independently of each other. The array of flexible electrodes (507) comprises between about 2 and 8 rows of flexible electrodes. The array of flexible electrodes comprise 2, 3, 4, 5, 6, 7, or 8 rows of flexible electrodes (508). The array of flexible electrodes comprise between about 1 and 8 flexible electrodes per row (508). The array of flexible electrodes comprise about 1, 2, 3, 4, 5, 6, 7, or 8 flexible electrodes per row (508). The array of flexible electrodes are arranged adjacent to each other (507). The array of flexible electrodes are arranged apart (507). The flexible electrodes in the same row are spaced about the width of one flexible electrode apart (508).

The electric weed control system can comprise a frame upon which is mounted an array comprising a plurality of flexible electrodes. The frame can be articulated as to allow the electric weed control system to more easily move over objects, obstacles, and broken terrain, e.g., curbs, sidewalks, rough ground, while having the flexible electrodes maintain contact with the ground. The individual flexible electrode units maintain contact with the ground and weeds. The individual electrode units are exposed on the bottom and sides of the units but enclosed by a shield to avoid any unintended instruction while the system is active.

The electric weed control system can comprise an array of flexible electrodes. The array can comprise three rows, the first two rows can comprise staggered sets of flexible electrodes with the last row comprising a full row of flexible electrodes, or the reverse arrangement. The first two sets of flexible electrodes can act as contact electrodes and the rear set of flexible electrodes can act as ground electrodes. A reverse configuration is also possible, e.g., the first two sets of flexible electrodes can act as ground electrodes and the rear set of flexible electrodes can act as contact electrodes. The array is segmented allowing it to adapt to landscape with different elevations and obstacles. The electric weed control system has a single connection point to the electrodes (the frame is not electrified). See FIG. 1.

In reference to the figures, FIGS. 6A-6C depicts a flexible electrode. The upper portion of the plurality of electrodes is of higher stiffness than the lower portion. The electrodes can be coupled to the laterally moveable boom via a removable fastener (601). The removable fastener can be selected from the group consisting of snap-fit, clamp, bolt, screw, or combinations thereof. FIG. 6A depicts the flexible electrode coupled to the frame, showing the flexibility/rigidity of the flexible electrode. The flexible electrode flexes while in contact with the ground. FIG. 6B depicts the flexible electrode in an unflexed position. The flexible electrode can comprise between about 2 and 8 strips, adjacent to each other. The flexible electrode can be separated into a top portion (602) and a lower portion (603). The top portion of the electrode is solid (602) and coupled to an adaptor comprising removable fasteners (601). FIG. 6C depicts the flexible electrode from the back, showing the flexible electrode flexed. The flexible electrode can comprise a non-conductive backing.

The flexible electrode can be segmented into sections between about the lower 25% of the length up to about 75% of the total length. For example, the flexible electrode can be segmented into sections on the lower 25% of the length of the flexible electrode, the lower 50% of the length of the flexible electrode, or the lower 75% of the length of the flexible electrode. These lower, segmented strips can move independently, in the forward and back direction to provide for maximum contact with the ground and plants. The flexible electrode can comprise stainless steel for the electrode and rubber for the insulator.

### Flexible Electrodes

Flexible electrodes can be coupled to the array. The flexible electrodes can be conductive reinforced polymer electrode, optionally a silicone backed spring steel. The flexible electrodes can be replaced individually as modular units with coupling means. The flexible electrode comprises a head with an extension, the extension is continuous upper half and discrete individual flaps in the lower half. The flexible electrodes receive power via the single power coupling in the array. The flexible electrodes make contact with the plant, which completes a “circuit,” causing electricity to flow from the flexible electrode through the plant, through its roots, and into the ground. The passage of electricity throughout the plant, including the root structure, allows for efficient killing of the plant. For example, some electrodes can make contact with the plant, other electrodes make contact with the ground. An electrical voltage is applied between the electrodes in contact with the plant and the electrodes in contact with the ground. As a result, electric current flows from an electrode in contact with a plant through the plant and its roots into the ground and to the electrode in contact with the soil.

The flexible electrodes can be conductive reinforced polymer electrode, optionally a silicone backed spring steel. The steel can be stainless steel. The flexible electrodes can be replaced individually as modular units with coupling means. The flexible electrode can comprise a head with an extension, the extension can be continuous upper half and discrete individual flaps in the lower half. See FIG. 2. The flexible electrodes have a balance between stiffness provided by the unity of the electrode on the upper part to avoid big weeds create a curtain effect and contact with nearby smaller weeds is not achieved; and flexibility in the lower part of the electrode by having small independent sub-electrodes than can better manage irregularity of the ground including cracks, small holes and ballast. The flexible electrodes can have a rigidity measured in terms of gigapascals (GPA). The maximum stiffness can be about 100 GPA.

The individual flexible electrodes can be coupled to the frame using removable fasteners. (601) The removable fastener can be selected from the group consisting of snap-fit, clamp, bolt, screw, or combinations thereof. Replaceable electrodes are configured to be attached and detached from the frame.

In reference to the figures, FIGS. 7A-7C depicts the electric weed control system comprising a segmented housing comprising an upper and lower sections. FIG. 7A front view of an array of flexible arrays on a flat (uniform) surface; FIG. 7B front view of the array configuration on a curb showing the upper rigid housing and the lower, flexible housing, that is configured to move in the vertical direction; FIG. 7C front view of array going over a curb (e.g., non-uniform surface), where the rigid upper housing is static and the lower flexible housing is configured to move in the vertical direction, allowing for constant contact between the flexible electrodes and the ground. The housing having an opening toward the ground can be segmented where individual segments in the housing, arranged horizontally, move independently. Further, the housing having an opening toward the ground can have a rigid upper half and a flexible lower half, where the flexible lower half can move in the vertical direction, allowing for better contact with the ground over uneven terrain and/or obstacles. This is shown in FIG. 7C over a curb, where, the rigid upper half of the housing is static, and the flexible lower half of the housing moves up and down over the curb. The entire housing can be segmented in the horizontal direction, where it allows different sections to move independently. The housing can be equally segmented, where each segment is about equal size, for example 2 or 4 equal segments. The housing can have an asymmetric configuration where the segments are not of equal size, for example a housing with one-quarter (25%) of the housing in one segment and the remaining three-quarters (75%) of the housing in a second segment.

The lower portion of the housing 106 is flexible and has sufficient material when flexing that adapts to the surface step of a curb (or other obstacle). Segmentation helps to avoid the presence of any gap between the lower portion of the housing 106 (e.g., curtain) and the curb step. A rise or lowering of a segment (on the upper and lower part of the curb, respectively) either manual or remotely will help in keeping almost constant distance from the rigid housing to the ground (at the upper and lower part of the curb) helping to minimize the presence of gaps on the lower portion of the housing 106 (e.g., curtain).

### Computer System

The electric weed control system described herein can be coupled to a computer system. The computer system can collect and process data to optimize the efficiency and operation of the electric weed control system. The electric weed control system can be electronically coupled to the computer system by physical connections, wireless connections, or both. Optionally, the electric weed control system, can be electronically coupled with a virtual computer system, for example operating remotely (e.g., “the cloud”).

A computer system can comprise a processor (Central Processing Unit, CPU) and supporting data storage. A computer system can comprise a programmable logic controller (PLC), microcontroller, distributed control system (DCS), or a combination thereof. Further, the data analysis can be implemented across multiple devices and/or other components local or remote to one another. The data analysis can be implemented in a centralized system, or as a distributed system for additional scalability. Moreover, any reference to software can include non-transitory computer readable media that when executed on a computer, causes the computer to perform a series of steps, such as the methods according to exemplary embodiments.

The computer systems described herein can include data storage such as network accessible storage, local storage, remote storage, or a combination thereof. Data storage can utilize a redundant array of inexpensive disks (“RAID”), tape, disk, a storage area network (“SAN”), an internet small computer systems interface (“iSCSI”) SAN, a Fiber Channel SAN, a common Internet File System (“CIFS”), network attached storage (“NAS”), a network file system (“NFS”), or other computer accessible storage. The data storage can be a database, such as an Oracle database, a Microsoft SQL Server database, a DB2 database, a MySQL database, a Sybase database, an object oriented database, a hierarchical database, or other database. Data storage can utilize flat file structures for storage of data.

The network that electronically couples the electric weed control system to the computer system, optionally equipment providing power and locomotion to the electric weed control system, can be a wireless network, a wired network or any combination of wireless network and wired network. For example, the network can include one or more of a fiber optics network, a passive optical network, a cable network, a telephony network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.1 1a, 802.1 1b, 802.15.1, 802.1 1n and 802.1 1g or any other wired or wireless network for transmitting and/or receiving a data signal. In addition, the network can include, without limitation, telephone line, fiber optics, IEEE Ethernet 802.3, a wide area network (“WAN”), a local area network (“LAN”), or a global network such as the Internet. Also, the network can support an Internet network, a wireless communication network, a cellular network, or the like, or any combination thereof. The network can further include one, or any number of the exemplary types of networks mentioned above operating as a standalone network or in cooperation with each other. The network can utilize one or more protocols of one or more network elements to which it is communicatively coupled. The network can translate to or from other protocols to one or more protocols of network devices. Although the network can be depicted or described herein as one network, it should be appreciated that according to one or more embodiments, the network can comprise a plurality of interconnected networks, such as, for example, a service provider network, the Internet, a broadcaster's network, a cable television network, corporate networks, and home networks.

All such publications (e.g., Non-Patent Literature), patents, patent application publications, and patent applications are herein incorporated by reference to the same extent as if each individual publication, patent, patent application publication, or patent application was specifically and individually indicated to be incorporated by reference.

While the foregoing invention has been described in connection with this preferred embodiment, it is not to be limited thereby but is to be limited solely by the scope of the claims which follow.

1. An electric weed control system comprising a housing having an opening facing toward the ground,
an array of flexible electrodes within the housing and which extend toward the opening,
whereby the flexible electrodes are configured to contact plants extending from the ground and configured to introduce electrical voltage to the plant,
optionally wherein the system is coupled to a vehicle in contact with a ground, optionally wherein the vehicle is a tractor, car, robotic, autonomous, drone, or combination thereof.

2. The electric weed control system of claim 1, wherein the housing extends at least as far as the flexible electrodes whereby ingress by small animals is inhibited and plants permitted.

3. The electric weed control system of claim 1, wherein the array of flexible electrodes are coupled to the housing via an isolator, optionally wherein the isolator is a block of nonconductive material.

4. The electric weed control system of claim 1, wherein an upper portion of the array of flexible electrodes is of higher stiffness than the lower portion.

5. The electric weed control system of claim 1, wherein the flexible electrodes are coupled to a laterally moveable boom via a removable fastener, optionally wherein the removable fastener is selected from the group consisting of snap-fit, clamp, bolt, screw, or combinations thereof.

6. The electric weed control system of claim 1, wherein the array of flexible electrodes comprises between about 2 and 8 rows of flexible electrodes, optionally the array of flexible electrodes comprise 2, 3, 4, 5, 6, 7, or 8 rows of flexible electrodes, optionally the array of flexible electrodes comprise between about 1 and 8 flexible electrodes per row, optionally the array of flexible electrodes comprise about 1, 2, 3, 4, 5, 6, 7, or 8 flexible electrodes per row.

7. The electric weed control system of claim 1, wherein the array of flexible electrodes are arranged adjacent to each other or the array of flexible electrodes are arranged apart.

8. The electric weed control system of claim 7, wherein the flexible electrodes in the same row are spaced about the width of one flexible electrode apart.

9. The electric weed control system of claim 1, wherein the array of flexible electrodes further comprises a non-conductive backing, optionally the flexible electrodes are segmented into strips.

10. The electric weed control system of claim 9, wherein the flexible electrode is segmented into strips between about the lower 25% of the length up to about 75% of the total length, optionally the flexible electrode is segmented into strips on the lower 25% of the length of the flexible electrode, the lower 50% of the length of the flexible electrode, or the lower 75% of the length of the flexible electrode.

11. The electric weed control system of claim 10, wherein the segmented strips can move independently.

12. The electric weed control system of claim 1, wherein the flexible electrode comprises between 2 and 8 strips, optionally the flexible electrode comprises 2, 3, 4, 5, 6, 7, or 8 strips, optionally the strips on the flexible electrode are adjacent, optionally there are spaces between strips of the flexible electrode.

13. The electric weed control system of claim 1, wherein the flexible electrodes, having a forward and a reverse surface, are paired with an insulator flap configured behind the reverse surface.

14. The electric weed control system of claim 13, wherein the insulator flap is about the same size and shape as the flexible electrode.

15. The electric weed control system of claim 1, wherein the housing having an opening toward the ground is segmented, wherein individual segments in the housing, arranged horizontally, move independently, or wherein the housing having an opening toward the ground comprises a rigid upper half and a flexible lower half, where the flexible lower half can move in the vertical direction.

16. The electric weed control system of claim 15, wherein the housing is equally segmented, optionally the housing is equally segmented into 2 or 4 equal-sized segments, or wherein the housing has an asymmetric configuration, wherein the segments are not of equal size, optionally the housing is segmented into a first one-quarter (25%) segment and second three-quarters (75%) segment.

17. The electric weed control system of claim 1, wherein the electric weed control system is coupled to the vehicle by a laterally movable boom extending from the vehicle.

18. The electric weed control vehicle of claim 1, wherein the vehicle has a front side, a rear side, a first and second side, the first and second sides extending between the front and rear sides, and where laterally moveable boom extends from the front side and is moveable laterally with respect to the main vehicle body in the direction of the first side and in the direction of the second side, optionally wherein laterally moveable boom is moveable such that at least a portion of the housing is extendible past the first side in a first lateral movement, and at least a portion of the housing extendible pas the second side in a second lateral movement, optionally wherein the laterally moveable boom moves laterally while maintaining a substantially constant distance from the ground upon which the vehicle moves.

19. A method of weed control comprising contacting a weed with the electric weed control system of claim 1 applying an electrical voltage between electrodes in contact with the plant and electrodes in contact with the ground, an electric current flows from an electrode in contact with a plant through the plant and its roots into the ground and to the electrode in contact with the soil, wherein the weed is contacted for a sufficient period of time to kill the weed.

20. The method of claim 19, wherein the voltage provided through the array is between about 1,000 V and 20,000 V, optionally the voltage provided through the array is between about 5,000 V and 15,000 V; 10,000 V and 20,000 V; 5,000 V and 12,500 V; or 7,500 V and 17,500 V, optionally the voltage provided through the array is about 1 kV, 2 kV, 3 kV, 4 kV, 5 kV, 6 kV, 7 kV, 8 kV, 9 kV, 10 kV, 11 kV, 12 kV, 13 kV, 14 kV, 15 kV, 16 kV, 17 kV, 18 kV, 19 k V, or 20 kV, optionally, wherein the voltage is about 10,000 V; and
wherein the power provided through the array is between about 1 kW and 20 kW, optionally the power is between about 1 kW and 5 KW, 5 KW and 10 KW, 2.5 kW and 7.5 kW, 2 KW and 8 KW, 1 kW and 10 KW, 10 KW and 20 kW, 15 kW and 20 kW, or 10 kW and 15 kW,
optionally wherein the power is about 1 kW, 2 KW, 3 kW, 4 KW, 5 KW, 6 kW, 7 kW, 8 kW, 9 kW, 10 kW, 11 kW, 12 kW, 13 kW, 14 kW, 15 kW, 16 kW, 17 kW, 18 kW, 19 kW, or 20 kW; and
wherein the contact time is between about 0.01 seconds and 1 second, optionally, wherein the contact time is between about 0.01 and 0.05 seconds, 0.02 and 0.08 seconds, 0.05 and 1 second, or 0.75 and 1 second, optionally wherein the contact time is about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, or 1 second, and wherein the current provided through the array is between 0.01 Amperes (A) and 10 Amperes (A), optionally between about 0.01 A and 1 A, 0.1 A and 10 A, 1 A and 10 A, 5 A and 10 A, 2.5 A and 7.5 A, or 0.05 A and 5 A, optionally wherein the current is about 0.01 A, 0.02 A, 0.03 A, 0.04 A, 0.05 A, 0.06 A, 0.07 A, 0.08 A, 0.09 A, 0.1 A, 0.2 A, 0.3 A, 0.4 A, 0.5 A, 0.6 A, 0.7 A, 0.8 A, 0.9 A, 1 A, 2 A, 3 A, 4 A, 5 A, 6, A, 7 A, 8 A, 9 A, or 10 A.
